(19) United States
(12) Patent Application Publication
(10) Pub. No.: US 2012/0037087 A1
(43) Pub. Date: Feb. 16, 2012

(54) CANINE TRAINING DEVICE FOR UNWANTED BITING

(76) Inventor: Amber Raudabaugh, Camp Hill, PA (US)

(21) Appl. No.: 12/856,207

(22) Filed: Aug. 13, 2010

(51) Int. Cl. A01K 15/02

(52) U.S. Cl. 119/719

(57) ABSTRACT

A user controlled device that produces a canine yelping sound for the correction of unwanted biting.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field

This application generally relates to canine training devices and methods, specifically to train canines to stop rough, excessive, or unnecessary biting/nipping.

2. Prior Art

Previously, a variety of techniques have been used to train canines. Few specifically target the problem of unwanted canine biting.

There are many training devices that emit computer generated noises. These noises signal to the animal that they are doing something wrong. This general remedy works best for the problems that animals don't naturally correct each other for. For example, if a canine doesn't walk nicely on a leash another canine would never be offended. Therefore, there is no natural remedy that they instinctively understand. However, dogs have always used a yelp to let another dog know that they have been hurt. The uses of computerized noises are not as effective as using the dogs own techniques for letting other animals or people know when their bite is too hard or unwanted. They immediately recognize their own language and respond to it better than any other method.

Although formal obedience training presents one possible solution, such training may be expensive and not affordable for everyone. Because of the high costs of professional training many people choose to not train their animals at all.

In worst case scenarios, people react with aggression and choose to hit or slap their animal to let them know they are doing something wrong. The animal does not understand this, because a fellow animal would not react this way to let them know of inappropriate behavior. Aggressive trainers create aggressive and/or scared animals that do not function well in the society we've created.

The common problem of unwanted canine biting is commonly corrected in a manner that creates more problems in the future or not corrected at all. Many of these methods actually worsen the situation and often lead up to euthanizing the animal. Unfortunately, innocent or not, our law states if an animal has bitten someone it must be destroyed.

U.S. Pat. No. 7,174,856 modifies an animal's behavior by the means of discharging an inert gas stream at an animal body. The effectiveness of this lies in two factors. One being the shock factor and the second is that it is very undesirable for the animal. Even though this may stop the animal from behaving in the undesired manner, it could easily result in other problems. These problems include creating a fear of people for the animal and for objects that resemble the gas spray canister.

U.S. Pat. No. 6,073,589 is a method of training an animal by the means of electrical correction stimulus. The administration of electricity to an animal is oftentimes inhumane and foreign to what is natural to them. This device promotes physical discomfort to an animal to get a result determined by its owner. These devices are easily misused and could result in very negative effects on the animal.

U.S. Pat. No. 5,749,324 is an apparatus for controlling animal behavior by using the sound the animal makes to determine what output the device makes. Although this device is humane and is more attentive to the dog's emotions rather than the owner's interpretation of them, it doesn't help with problems that aren't sound related.

U.S. Pat. No. 5,061,918 is a device for modifying the undesirable behavior of animals by the use of high-intensity sounds. This device is primarily used to stop dogs from barking. Because dogs do not correct each other for barking there is no natural remedy to stop them from barking. However, biting is something that can be corrected faster by using what is natural to them.

### SUMMARY

In accordance with one embodiment, a bite correction training device comprises an outer shell surrounding the speaker that emits the sound of a dog in pain, commonly referred to as a yelping sound.

In one preferred embodiment the device is a fully integrated unit. It consists of five major components: the outer shell, the power source, the circuit board, the control button, and the speaker with the sound file.

### DRAWINGS

### Figures

The foregoing summary, as well as the following detailed description of the preferred embodiments, is better understood when read in conjunction with the attached drawings. For the purpose of illustrating the device, there is shown in the drawings embodiments that are presently preferred, it is being understood, however, that the invention is not limited to the specific apparatus, system, examples and instrumentalities disclosed.

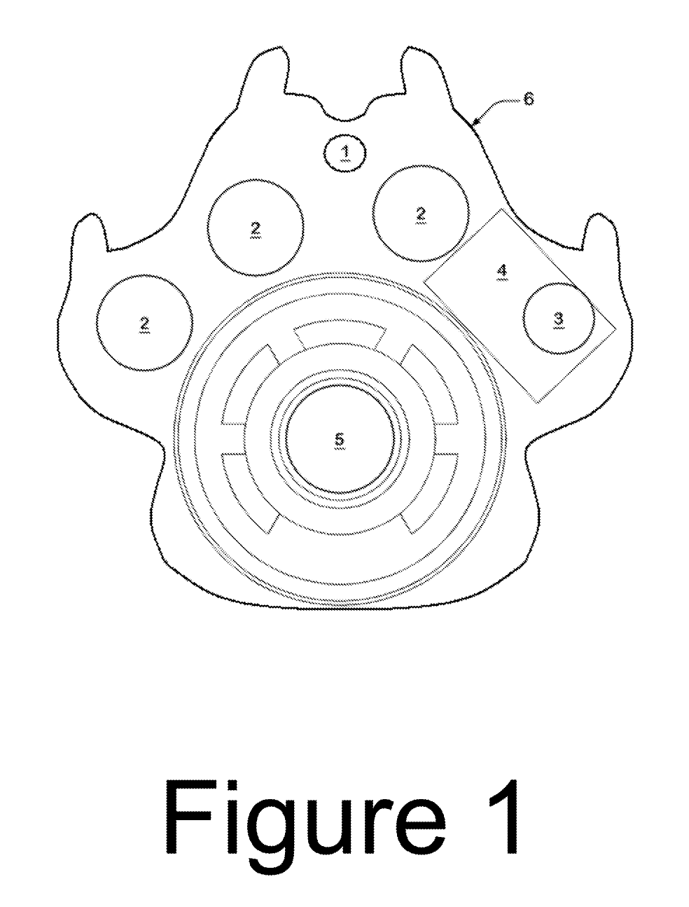

FIG. 1: Internal Components

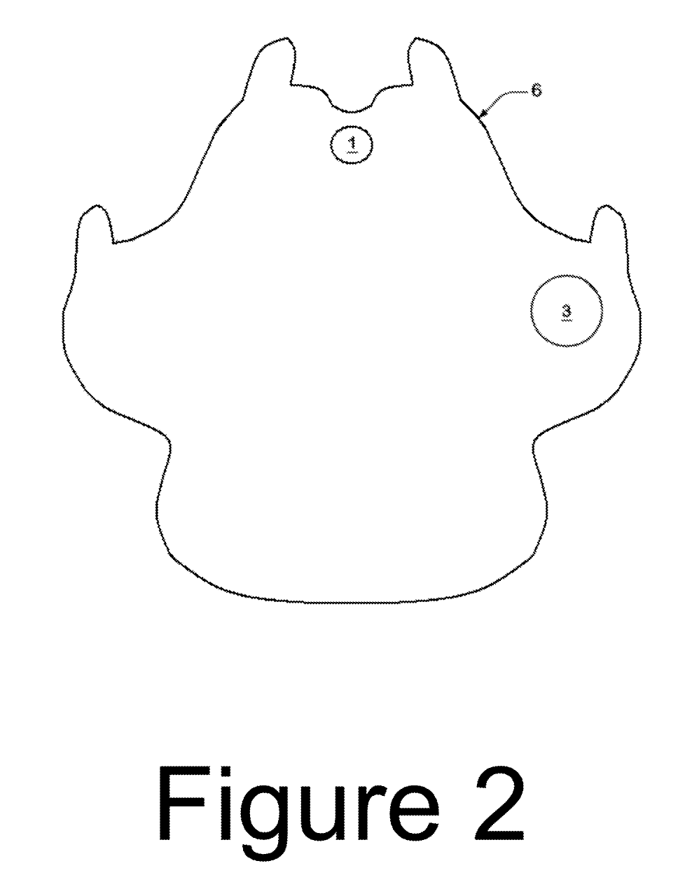

FIG. 2: Front View

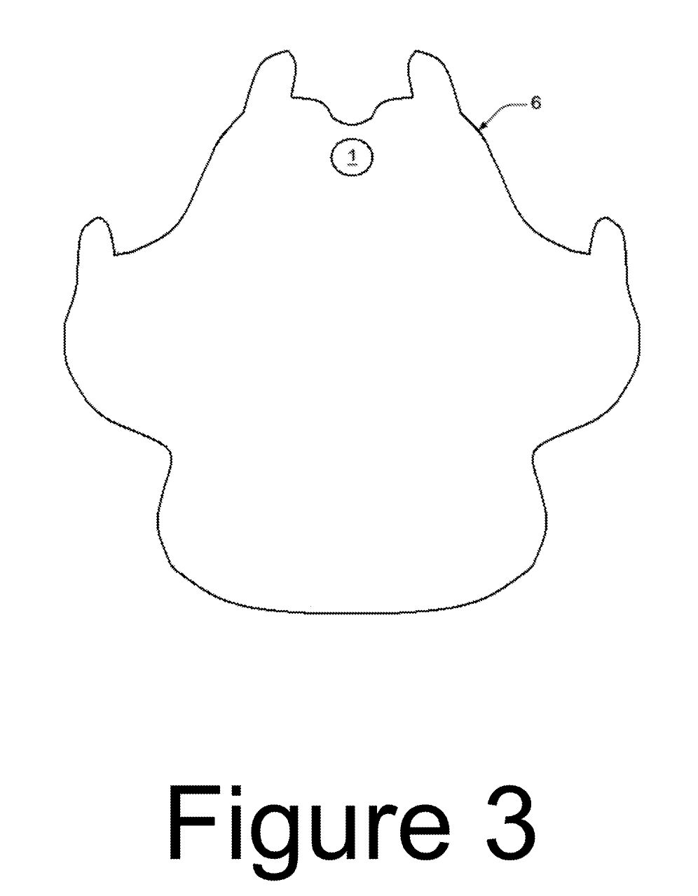

FIG. 3: Rear View

### DRAWINGS

### Reference Numerals

1 Attachment Hole
2 Power Source
3 Control Button
4 Circuit Board
5 Speaker and Sound Media
6 Outer Shell

### DETAILED DESCRIPTION

### FIGS. 1, 2, 3

FIG. 1: In a preferred embodiment, the internal components and outer shell 6 are integrated into an assembly that resembles a paw print. However, the outer shell can be of any shape and does not necessarily have to be a paw print. In a preferred embodiment, the assembly comprises an outer shell 6 that is plastic. However, the outer shell 6 can be of any other material, such as rubber, metal, foam, etc.

In a preferred embodiment, an attachment hole 1 is integrated into the assembly, allowing flexibility for attaching the device to car keys or any other able object. However, the attachment hole 1 can be of any size, shape, or not exist at all.

In a preferred embodiment, a power source 2 is placed within the assembly and consists of 3 batteries. However, the power source 2 can be of any means and is not limited to standard batteries. For example, solar power is another option in conjunction with a re-chargeable battery.

In a preferred embodiment, a control button 3 is integrated into the assembly and is made of plastic. However, the control button can be of any other material, such as rubber, metal, foam, etc. Also, it doesn't have to be a button, but rather any user controlled switch to activate the media file.

In a preferred embodiment, a circuit board 4 is placed within the assembly and is used to interconnect the other internal components including the control button 3, the power source 2, the speaker and sound media 5.

In a preferred embodiment, a speaker and sound media 5 is integrated with a pre-recorded canine yelping sound. However, the speaker and sound media can have any sound of a dog in pain.

FIG. 2: In a preferred embodiment, the assembly integrates a control button 3 that is visible and able to be pushed with the device being closed. The attachment hole 1 is also visible from the front with the assembly closed.

FIG. 3: In a preferred embodiment, the assembly has an attachment hole 1 that can be viewed from the back when the device is closed.

It is understood that the device is not limited to the disclosed statements, but on the contrary, is intended to cover various modifications and equivalent arrangements included within the spirit and scope of the disclosed embodiments. Without further elaboration, the foregoing will so fully illustrate the device, that others may by current or future knowledge, readily adapt the same for use under the various conditions of service.

### Operation—FIGS. 1, 2, 3

The manner of using the training device for the correction of canine biting is common to most handheld training devices that emit a sound. The holder of the device would press the control button 3 when the canine is undesirably biting. The circuit board 4 interconnects the other internal components; including the control button 3, the power source 2, the speaker and sound media 5. Pushing the control button 3 results in the media file playing from the speaker 5. This process should be repeated every time an unwanted bite occurs.

### CONCLUSION, RAMIFICATIONS, AND SCOPE

Accordingly, the reader will see that the canine training device can be effectively used to teach a canine what is acceptable and what is not acceptable when it comes to biting.

A primary object of the present device is to provide a safe, humane device for readily training a canine not to bite.

Another object of the device is to provide a compact, low-cost canine training device that is small and lightweight enough to be easily carried by humans.

Another object of the device is to be user friendly for people of all ages that are capable of pushing the control button whenever they feel they have been undesirably bitten.

An additional object of the device is to teach more canines not to bite in order to save more from being euthanized in the future.

Although the description above contains many specificities, these should not be construed as limiting the scope of the embodiments but as merely providing illustrations of some of the presently preferred embodiments. For example, the outer shell can be of any shape and size, the power source does not have to be 3 batteries, the speaker can be of any dimension, the sound file does not have to be pre-recorded but rather a recordable sound file, and the device can be altered to have multiple levels of sound to correct different levels of biting, etc.

Thus the scope of the embodiments should be determined by the appended claims and their legal equivalents, rather than by the examples given.

1. A canine training device, comprising:
an outer shell; a control button; a circuit board; a power source; a speaker; and sound media, whereby the device produces a yelping noise each time the control button is pushed.

2. The canine training device of claim 1 wherein said sound media is the sound of a dog in pain or, commonly referred to as, a canine yelping sound.
